(19) United States
(12) Patent Application Publication
(10) Pub. No.: US 2009/0165377 A1
(43) Pub. Date: Jul. 2, 2009

(54) METHOD FOR PRODUCING SYNTHETIC GAS USING AN OXYGEN-CONTAINING GAS PRODUCED BY AT LEAST ONE GAS TURBINE

(75) Inventors: Daphne Koh, Paris (FR); Pascal Avart, Bussy Saint Georges (FR); Bhadra S. Grover, Sugar Land, TX (US)

Correspondence Address: AIR LIQUIDE;Intellectual Property, 2700 POST OAK BOULEVARD, SUITE 1800, HOUSTON, TX, 77056, US

(73) Assignee: L'Air Liquide, Societe Anonyme Pour L'Etude Et L'Exploitation Des Procedes Georges Claude, Paris Cedex 07 (FR)

(21) Appl. No.: 12/067,411

(22) PCT Filed: Sep. 15, 2006
(86) PCT No.: PCT/FR2006/050894

§ 371 Date: Nov. 3, 2008

(30) Foreign Application Priority Data
Sep. 19, 2005 (FR) 0552804

(51) Int. Cl. C10J 3/68; F02C 3/34; C10J 3/00

(52) U.S. Cl. 48/76; 60/39.52; 48/203

(57) ABSTRACT

The invention concerns a method for producing synthetic gas on an industrial site comprising at least one gas turbine wherein the oxygen-containing gas produced by the gas turbine is upgraded in a combustion implemented on the industrial site or in a heat recovery unit of the industrial site. Preferably, the oxygen-containing gas is used as oxidant of the combustion thereby enabling the reaction for forming the syngas. The invention also concerns a method for controlling the introduction of the oxygen-containing required for combustion to enable the syngas to be formed into a syngas reactor and an associated device.

The present invention relates to a process for producing syngas and electricity, in which the oxidizer necessary for combustion to enable the syngas formation reaction consists of an oxygen-containing gas produced by at least one gas turbine.

The invention applies to various branches of activity, such as heavy chemicals, the petrochemical industries, the refining industry, the energy industry, all concerned by environmental conservation. All these industries are capable of converting heavy hydrocarbons to chemicals that can be utilized for producing a syngas. A syngas is a gas mixture containing at least CO, H₂, CH₄, CO₂, N₂, Ar and H₂O obtained by steam methane reforming (SMR), by partial oxidation (POX) of hydrocarbons, by autothermal reforming (ATR), by convective reforming, by secondary reforming, or by heat exchange reforming. All these methods implement a combustion reaction in order to supply the heat necessary for the syngas formation reaction.

The present invention relates to syngas production sites in which at least one gas turbine is also present. According to the invention, “gas turbine” (CT) means a device comprising at least one air compressor, one combustion chamber and a flash turbine. The site may have a plurality of gas turbines. In the gas turbine, the compressed air produced is introduced with at least one fuel into the combustion chamber of the turbine and the flue gases produced pass through the flash turbine to generate electricity using a generator. In general, these gases then pass through a waste heat boiler to produce steam. The fuel of the gas turbine is usually natural gas, but may comprise hydrogen or syngas produced by the syngas production unit or a liquid hydrocarbon fuel.

It is the object of the present invention to propose a syngas production process having improved energy efficiency by combining the syngas production process with a cogeneration unit.

For this purpose, the invention relates to a method for supplying oxidizer to the combustion device of a unit for producing syngas from the exhaust gas produced by a gas turbine, in which the exhaust gas flow introduced into the combustion device is controlled according to the value of the oxygen concentration and/or of the pressure in the furnace of the syngas production unit.

The invention also relates to a device for implementing said method.

Other features and advantages of the invention will appear from a reading of the description that follows. The exemplary embodiments of the invention are provided as nonlimiting examples, illustrated by the appended drawings in which:

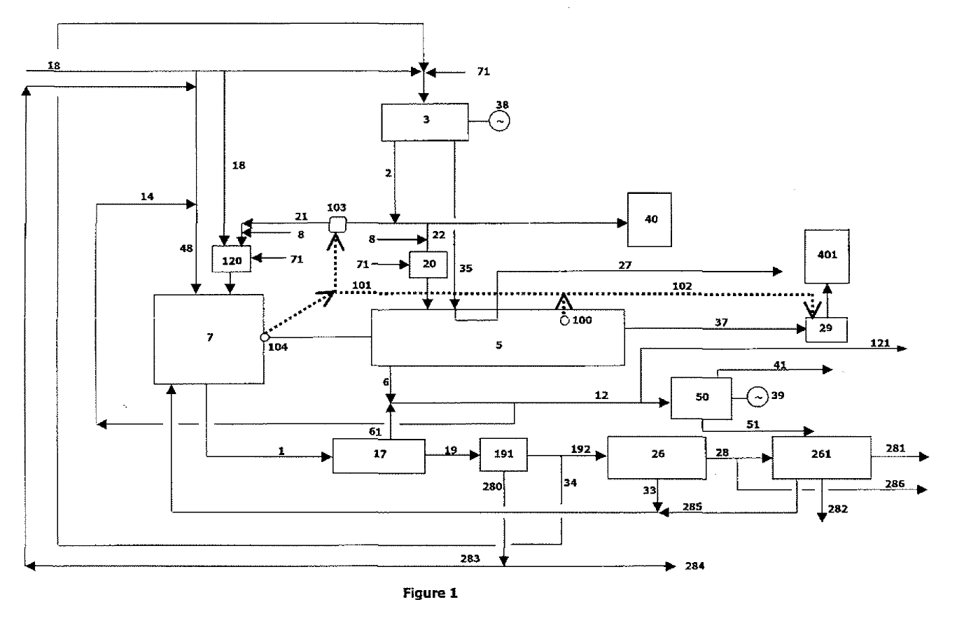

FIGS. 1 to 3 are schematic views of at least three alternatives of the syngas production process according to the invention, also producing electricity and preheated air,

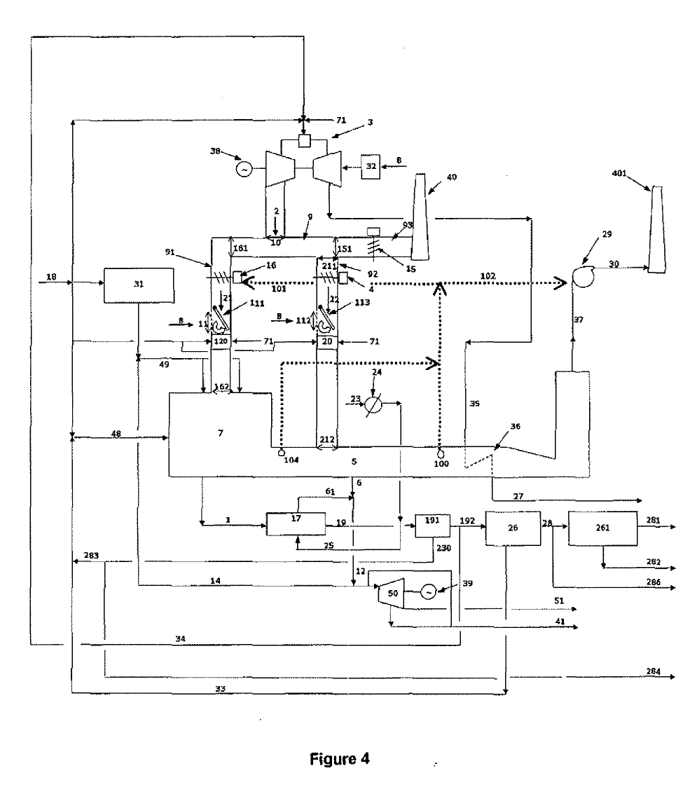

FIGS. 4 to 8 are diagrams of the device for distributing a turbine exhaust gas and a secondary oxygen-containing gas to a syngas reactor and to the heat recovery unit associated with the syngas production unit.

The invention therefore relates to a process for producing syngas on an industrial site comprising at least one gas turbine, in which the oxygen-containing gas produced by the gas turbine is utilized in the combustion reaction implemented for producing syngas: according to the invention, the oxidizer necessary for the combustion to enable the syngas formation reaction consists of an oxygen-containing gas produced by at least one gas turbine. The facilities enabling the production of the raw syngas may be a steam reforming reactor (SMR), followed by a secondary reforming reactor, or a partial oxidation (POX) reactor using hydrocarbons to produce the raw syngas. The raw syngas comprises hydrogen, carbon monoxide, carbon dioxide and other compounds. It may also involve a reactor for implementing an ATR process or a convective reforming process. These syngas production reactions take place at high temperature, requiring combustion in a reactor for implementing and maintaining the synthesis reaction. This combustion demands the presence of an oxidizer which, according to the invention, issues at least partly from the gas turbine. This combustion is implemented using burners fed with the exhaust gas from the turbine and with an oxidizer. The latter is usually natural gas, but it may also be a liquid or solid containing hydrocarbons.

Thus, said oxidizer is an oxygen-containing gas which consists fully or partially of the exhaust gas from the gas turbine. In fact, the gas turbine produces an exhaust gas generally comprising 13% to 16% by volume of oxygen on wet gas. According to the invention, the exhaust gases are recovered and introduced into the burners of the SMR, ATR, POX or the convective reformer for implementing the combustion necessary for the syngas production reaction. These exhaust gases generally have a temperature of between 450° and 650° C.

One direct consequence of the implementation of the method according to the invention is that the heat produced during the combustion to enable the syngas formation reaction can then be used to produce steam or preheated air. In fact, in certain cases, due to the use of the oxygen-containing gas from the gas turbine, the syngas production process produces surplus heat compared to a method only using air for the combustion implemented in the syngas production. This surplus heat can be utilized by heating any type of fluid, and in particular, water or water vapor or air, by contacting the latter fluids in a heat exchanger with the syngas produced and/or the flue gases produced by the combustion in the syngas reactor and/or the flue gases produced by the combustion in the gas turbine.

According to an alternative of the invention, part of the oxygen-containing gas produced by the gas turbine can be used in a heat recovery unit. This alternative applies when the gas turbine produces a quantity of oxygen-containing gas that is larger than that necessary for the combustion required to enable the syngas formation reaction. The surplus oxygen-containing gas can then be used as oxidizer in the combustion implemented by a heat recovery unit. According to the invention, the heat recovery unit may be the combustion gas heat recovery zone from the syngas production device. This zone is present on all syngas production sites and serves to recover the heat from the exhaust gases produced by the combustion that enables the syngas formation reaction. The combustion implemented in this zone is that of the hydrocarbons used in the production of syngas and of the oxygen-containing gas produced by the gas turbine. This zone is called the combustion gas heat recovery zone in the present invention. The heat recovery unit may also be a steam production unit or heat recovery steam generator (HRSG). In this case, the steam produced can be used to generate electricity using a steam turbine, or it may also be used for an industrial process using steam (in which case, it is a product exported from the site). The heat recovery unit may also be an air preheater.

According to a particular embodiment of the invention, the air compressed by the compressor of the gas turbine can be heated in a heat exchanger built into the convective zone of the syngas production facility.

According to the invention, the flow of exhaust gas from the turbine introduced into the burners of the syngas production unit is controlled. This control can be carried out by at least one control means placed on the device for distributing exhaust gas from the turbine to the combustion device: it may be a valve or a louver placed on the distribution line of this gas, or it may be an extractor fan placed at the outlet of the exhaust gases from the syngas production unit. This extractor fan creates a vacuum in the combustion furnace of the syngas production unit, indirectly causing suction of the exhaust gases from the turbine into the burners of the syngas production unit.

Preferably, the flow of exhaust gas introduced into the combustion device is controlled so that the oxygen concentration downstream of the combustion chamber of the syngas production unit is between 2 and 3% by volume of dry gas and/or the pressure in the furnace of the syngas production unit is between 5 mm and −15 mm H₂O. In practice, an oxygen pressure and/or concentration sensor is generally placed downstream of the combustion chamber of the syngas production unit, in order to measure this concentration and this pressure. Said sensor is connected to the means for controlling the flow of exhaust gas to be introduced into the combustion device by feedback loop in order to servocontrol the introduction of the exhaust gas from the turbine to said concentration and/or said pressure.

Since the combustion chamber of a syngas production unit often is under vacuum with regard to the atmospheric pressure, the invention advantageously uses this property to ensure the introduction of the exhaust gases from the gas turbine into the burners of the combustion chamber of the syngas production unit: these are readily taken in; no compression means is necessary to introduce them into the burners.

According to the invention, it is also possible to control the introduction, into the combustion chamber of the syngas production unit, of the oxygen-containing gas necessary for the combustion enabling the syngas formation reaction to take place. Thus:
when the gas turbine operates, at least part of the oxygen-containing gas produced by the gas turbine is introduced into the combustion chamber of the syngas production device according to the method of the invention,
when the gas turbine does not operate, atmospheric air or oxygen is introduced into the combustion chamber of the syngas production device. This serves to maintain the introduction of an oxygen-containing gas into the combustion chamber of the syngas production unit when the gas turbine is not in operation, for example in case of shutdown. In this case, the oxygen-containing gas used in the combustion chamber may be atmospheric air. This air is generally introduced using a forced draft fan. Prior to its introduction into the reactor, this air is preferably heated to the temperature of the oxygen-containing gas leaving the gas turbine, which is about 450° C. to 650° C., for example using burners. The secondary oxygen-containing gas may also be pressurized oxygen issuing from an air separation unit (ASU), which is equivalent to implementing an oxycombustion. This oxygen may also be introduced into the secondary reformer of the syngas production device.

According to a particular embodiment, the method also provides that:
when the gas turbine is in operation, at least part of the oxygen-containing gas produced by the gas turbine is introduced into a combustion gas heat recovery zone and/or into a steam production unit,
when the gas turbine is not in operation, atmospheric air is introduced into the combustion gas heat recovery zone and/or into a steam production unit.

In general, the atmospheric air is heated before being introduced into the combustion chamber of the syngas production unit, in the combustion gas heat recovery zone and/or in a steam production unit. The atmospheric air is generally heated by a burner. The atmospheric air introduced into the combustion gas heat recovery zone and/or into a steam production unit may be heated using a burner fed with at least part of the exhaust gas produced by the syngas production device. The recirculation of said exhaust gas serves to increase the production of steam while reducing the NOₓ partial pressure.

The invention further relates to a device for supplying oxidizer to the combustion device of a unit for producing syngas from the exhaust gas produced by a gas turbine for implementing the controlled feed method described above. Said device consists of at least two lines:

the first line comprising:
an opening cooperating with the gas turbine and enabling the introduction of the exhaust gas into said first line,
an opening cooperating with the second line and enabling the removal of the gas present in the first line to the second line,
an opening enabling the removal of the gas present in said line to the atmosphere,

the second line comprising:
an opening cooperating with the first line and enabling the introduction of the exhaust gas into said second line,
an opening enabling the introduction of the secondary oxygen-containing gas into said second line,
means for controlling the opening enabling the introduction of the secondary oxygen-containing gas into the second line, enabling either the opening, or the closure of the opening,
an opening enabling the removal of the oxygen-containing gas present in the second line to the combustion chamber of the syngas production device,
means for regulating the flow of exhaust gas.

One of the means for controlling the opening for introducing secondary oxygen-containing gas is a hatch. The hatch serves to open or close said opening: it is opened to introduce the secondary oxygen-containing gas into the line and it is closed to prevent the introduction of the secondary oxygen-containing gas into the line. Another means for controlling the opening serving to introduce secondary oxygen-containing gas is an air blower.

The means for regulating the exhaust gas flow into the second line generally consists of inlet guide vanes or louvers. Regulation may extend to the total closure of the exhaust gas flow from the turbine. According to a preferable embodiment of the invention, the means for regulating the flow of exhaust gas from the gas turbine (3) into the second line is servocontrolled by an oxygen pressure and/or concentration sensor located downstream of the combustion chamber of the syngas production unit.

The invention also relates to an alternative of the previous device enabling the distribution of exhaust gas from the turbine and of a secondary oxygen-containing gas into the combustion device of the syngas production unit, and also into the combustion gas heat recovery zone and/or to a steam production unit. According to this alternative, the device comprises three lines and:

the first line comprises another opening cooperating with the third line and enabling the removal of the gas present in the first line to the third line,

the third line comprises:
an opening cooperating with the first line and enabling the introduction of the main oxygen-containing gas into said third line,
an opening enabling the introduction of the secondary oxygen-containing gas into said second line,
means for controlling the opening enabling the introduction of the secondary oxygen-containing gas into the third line enabling either the opening, or the closure of the opening,
an opening enabling the removal of the oxygen-containing gas present in the third line to the combustion gas heat recovery zone and/or to the steam production unit.

This device is suitable for implementing the method for controlling the introduction, into the combustion chambers of a syngas production device, of the oxygen-containing gas necessary for combustion to enable the syngas formation reaction previously defined. It serves to select the type of oxygen-containing gas to be introduced into the combustion chamber of the syngas unit and into the boiler of the steam production unit. The means for controlling the opening enabling the introduction of the oxygen-containing gas into the third line is the same type as that described for the second line. The third line may also comprise means for regulating the flow of exhaust gas; this regulating means generally consists of inlet guide vanes or louvers.

The first line of the alternative device may comprise means for dividing the exhaust gas from the gas turbine between the second line and the third line, and, preferably, said dividing means are servocontrolled by an oxygen concentration sensor located downstream of the combustion chamber of the syngas production unit. Thus, if the oxygen concentration downstream of the combustion chamber of the syngas production unit is too low, more oxygen-containing exhaust gas from the gas turbine can be introduced into the second line leading to the combustion device of the syngas production unit, and less into the third line.

The first line comprises an opening enabling the removal of the oxygen-containing gas present in said line to the atmosphere. According to the invention, the removal of the gas present in the first line to the atmosphere is provided when the gas turbine is under partial or no load and does not produce exhaust gas. The partial or total removal of the gas may also be provided when the gas turbine operates but when the syngas production device is under partial load or shut down.

The previous device normally comprises duct burners placed in the second and third lines. These burners serve to heat the oxygen-containing gases, and this is useful in particular when the oxygen-containing gas is atmospheric air or oxygen, or when steam production is to be increased by heating the main oxygen-containing gas present in the third line. Thus, the burners are generally placed in the second and third lines downstream of the opening enabling the introduction of the secondary oxygen-containing gas into the lines, in comparison with the flow direction of the secondary oxygen-containing gas in the lines.

Preferably, the first line comprises an opening enabling the removal of the oxygen-containing gas present in the line to the atmosphere. This opening, which enables the removal of the oxygen-containing gas present in the line to the atmosphere, generally cooperates with a line comprising means for regulating the exhaust gas flow.

FIGS. 1 to 8 illustrate the device and method according to the invention. In these figures, the numbers have the following meaning:
1 Raw syngas
2 Exhaust gas from the gas turbine
21, 22 Oxygen-containing gas
3 Gas turbine
4 Louvers
5 Combustion gas heat recovery zone
6 Steam from syngas production device
7 Syngas production device
8 Atmospheric air
9, 91, 92, 93, 94 Oxygen-containing gas lines
10 Opening of the first line 9 enabling the introduction of the main oxygen-containing gas
11 Opening of the second line 91 enabling the introduction of the secondary oxygen-containing gas
111 Hatch or air blower
112 Opening of the third line 92 enabling the introduction of the secondary oxygen-containing gas
113 Hatch or air blower
12, 121 Steam
120 Burners
13 Steam production unit
14 Steam recycled to the syngas production unit
15 Louvers
151 Opening of the line enabling removal of the main oxygen-containing gas to the atmosphere
16 Louvers
161 Opening of the first line 9 enabling the removal of the oxygen-containing gas to the second line 91
162 Opening of the second line 91 enabling the removal of the oxygen-containing gas to the combustion chamber of the syngas production device
17 Unit for recovering steam from the syngas production device
171 Secondary reformer
172 Air separation unit (ASU)
173 Purified oxygen to the secondary reformer
174 Pressurized purified oxygen for combustion
175 Purified oxygen in gas or liquid form for export
18 is Hydrocarbon raw material and/or fuel
181, 182, 183 Louvers
19 Cooled syngas
191 Carbon dioxide stripper
192 Low CO₂ syngas
20 Burners
211 Opening of the first line 9 enabling the removal of the oxygen-containing gas to the third line 92
212 Opening of the third line 92 enabling the removal of the oxygen-containing gas to the combustion gas heat recovery zone
23 Water
230 CO₂ removed
24 Boiler preheater
25 Hot water
26 Syngas purification unit (for example membrane producing oxogas, with an H₂/CO mixture ratio between 1.1 and 2.1)
261 Hydrogen and carbon monoxide separation units
27 Exported hot air
28 Purified syngas
280 CO₂ removed
281 Purified hydrogen
282 Purified CO
283 CO₂ removed for recycling to the syngas production device
284 CO₂ removed for compression and liquefaction
285 Mixture of purged gas used as fuel in the combustion chamber of the syngas production device
286 Exported syngas (for example, oxogas)
29 Extractor fan
30 Combustion products
300 Exhaust gas recycle line
31 Hydrocarbon pretreatment unit
32 Air temperature controller
33 Mixture of purged gas from the purification unit
34 Syngas used as fuel in the gas turbine
35 Compressed air
36 Air preheater
37 Combustion products
38 Generator
39 Generator
40, 401 Discharge stack
41 Steam from gas turbine
42 Solid or liquid hydrocarbon fuels
43 Steam exported from site
44 Exhaust gas
45, 46 Louvers
47 Steam for gas turbine
48 Mixture of fuels for the combustion chamber of the syngas production device
49 Mixture of pretreated hydrocarbons and steam
50 Steam turbine
51 Steam condensates from the steam turbine
61 Steam from the unit for recovering steam from the syngas production device
71 Hydrocarbon raw material and/or fuel other than that used for syngas production
81, 82 Atmospheric air compressed by a blower
100 Oxygen concentration analyzer
100, 102 Feedback loop
103 Means for controlling the exhaust gas flow from the gas turbine
104 Pressure sensor

FIG. 1 shows a schematic view of the syngas production process according to the invention, also permitting the production of electricity, steam and preheated air. The syngas 1 is produced from hydrocarbons 18 in the unit 7 either by steam reforming, or by partial oxidation or gasification, or by autothermal or secondary reforming, or by convective reforming, or by heat exchange reforming with a hydrocarbon fuel. The combustion uses as oxidizer an oxygen-containing gas 21 which is partly the exhaust gas 2 produced by the gas turbine 3. This gas turbine is fed with hydrocarbons 18 identical to those used for the syngas formation reaction or different hydrocarbons 71, and it produces electricity 38 and/or compressed air 35.

The heat liberated by the combustion enabling the syngas formation reaction to take place in the combustion chamber of the unit 7 is recovered in the combustion gas heat recovery zone 5 which produces steam 6 and heats the compressed air 35 producing preheated air 27, the latter issuing from the compressed air 35 produced by the compressor of the gas turbine 3. The steam 6 is added to that 61 already produced by the unit 17 for recovering steam from the syngas production device, said unit 17 being intended to recover the waste heat from the cooled syngas 19. Part 22 of the exhaust gas from the gas turbine 2 issuing from the gas turbine 3 feeds the heat recovery unit 5, particularly during the startup of the syngas production unit 7. If the gas turbine 3 is inoperative and does not produce oxygen-containing exhaust gas 2, atmospheric air 8 is used as oxidizer in the combustion chambers of the unit 7 and/or in the combustion gas heat recovery zone 5. This air 8 is generally preheated using burners 120 and 20, supplied with fuels 18 and/or 71. In this case, the exhaust gas 2 from the turbine 3 is removed via the stack 40. In this arrangement, part 121 of the steam 12 produced by the steam recovery unit 17 and the combustion gas heat recovery zone 5 may be directly exported, while another part 41 is exported after having been expanded in the steam turbine 50 to produce more electricity 39 and steam condensates 51. Another part 14 of the steam 12 produced forms a mixture 48 with the hydrocarbons 18 before their introduction into the unit 7.

As in any syngas production unit, an exhaust gas 37 is produced and extracted by the fan 29 to the discharge stack 401. The cooled syngas 19 is purified in the carbon dioxide stripper 191 to produce a syngas 192 containing about 50 ppm of carbon dioxide. Part 280 or all 280 of the CO₂ removed can be recycled to the syngas production device by mixing with the hydrocarbons and steam 14. The other part 284 or all 280 of the CO₂ removed may be compressed and liquefied for export. Part 34 of the low CO₂ syngas is used as fuel in the gas turbine 3. The remainder of the low CO₂ syngas 192 is purified in the purification unit 26 which adjusts the H₂/CO ratio to produce a purified syngas 28 whereof part 286 is exported. The products 33 removed from the low CO₂ syngas 192 may be recycled to the syngas production unit 7. The purified syngas 28 may also be introduced into the H₂ and CO separation units 261 to produce purified hydrogen 281 for export or compression on the one hand, and purified CO 282 for export or compression on the other. The mixture of purged gas issuing from the separation units 261 is used as fuel in the combustion chamber of the syngas production device.

For implementing the invention, an analyzer 100 measures the pressurized oxygen concentration in the zone downstream of the combustion chamber and a pressure sensor 104 measures the oxygen concentration at the outlet of the furnace 7. The means for controlling the exhaust gas flow from the gas turbine 103 is servocontrolled by a feedback loop 101, to the values given by the analyzer 100 and the sensor 100 and increases or decreases the flow of exhaust gas 2 from the gas turbine 3 in order to maintain the oxygen pressure and concentration of the syngas production unit within normal operating limits. Similarly, the fan 29 for extracting the combustion products 37 from the syngas production unit is servocontrolled by a feedback loop 102, to the values given by the sensor 104 and the analyzer 100 and increases or decreases its rate in order to influence the flow of exhaust gas 2 from the gas turbine 3.

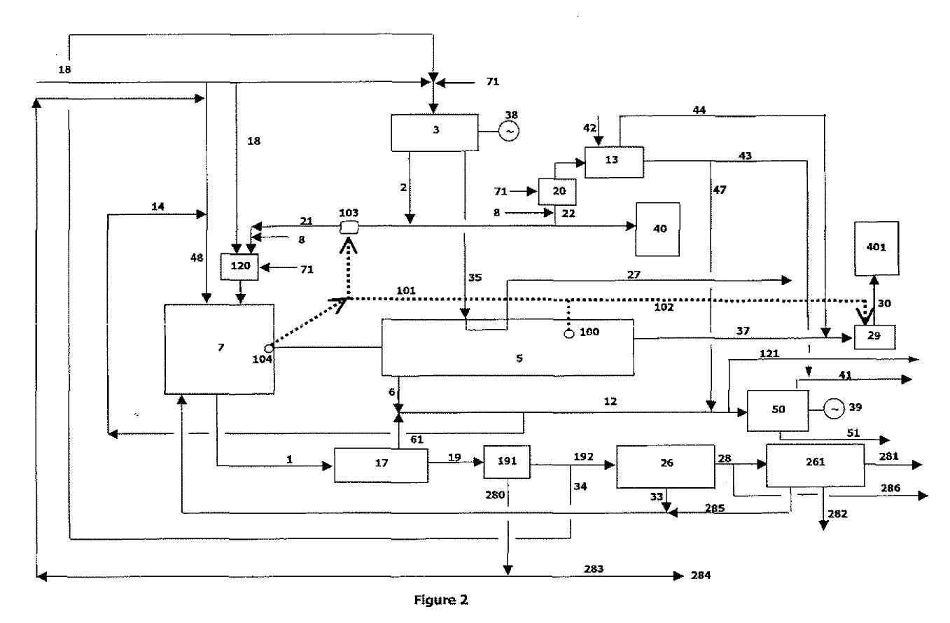

FIG. 2 shows a schematic view of a syngas production process like the one in FIG. 1, except that this process comprises a steam production unit 13 supplied with hydrocarbon fuels 42 and with part 22 of the oxygen-containing exhaust gas 2 from the gas turbine 3. The steam production unit 13 is generally a boiler burning heavy or solid fuels 42 which cannot be used in the gas turbine 3 or in the syngas production device 7. The steam production unit 13 produces steam of which part 47 is mixed with the steam 12 produced by the unit 17 for recovering steam from the syngas production device, and the remainder 43 is mixed with the steam 41 expanded by the turbine 50. The exhaust gases 44 from the steam production unit 13 are mixed with the combustion products 37 from the unit 7.

For the two configurations in FIGS. 1 and 2, syngas production can continue even if the gas turbine is shut down, thanks to the use of atmospheric air. It is also possible to uncouple the gas turbine from the syngas production unit using the discharge stack 40. For example, even if the syngas production unit stops operating, the gas turbine can still be used to produce electricity and steam.

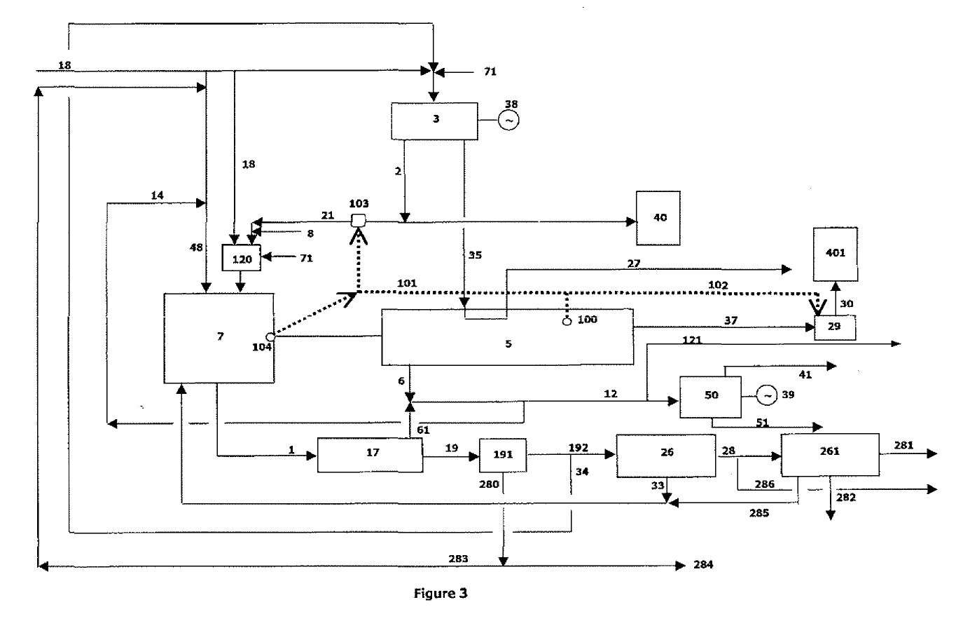

FIG. 3 shows a schematic view of a syngas production process like the one in FIG. 1, except that this process comprises a single oxygen-containing gas line. This flowchart is used when the heat required for the combustion necessary for the syngas formation reaction is sufficiently supplied by all the oxygen-containing gas from the gas turbine.

FIG. 4 shows a schematic view corresponding to the method in FIG. 1 showing details of the device for distributing the main oxygen-containing gas and the secondary oxygen-containing gas into the combustion chamber of the syngas production device 7. The three lines 9, 91 and 92 enable the distribution of the oxygen-containing exhaust gas 2 from the turbine 3 or of the atmospheric air 8 via the following openings:

the opening 10 enables the introduction of the oxygen-containing gas 2 from the gas turbine 3 into the line 9,

the opening 161 and the opening 211 respectively enable the introduction of part 21 of the oxygen-containing gas 2 into the line 91 and part 22 of the oxygen-containing exhaust gas 2 into the line 92,

the louvers 16 and 4 enable the regulation of the flow of the gas 21 and of the gas 22,

the opening 11 and the opening 112 respectively enable the introduction of the atmospheric air 8 into the line 91 and into the line 92,

the hatches 111 and 113 serve to select the introduction of either the oxygen-containing gas 21 or 22, or of the atmospheric air 8 into their respective line 91 or 92,

the burners 120 and 20 serve to heat the gas flowing in the lines 91 and 92,

the opening 162 serves to remove the gas present in the line 91 to the combustion chamber of the syngas production device 7,

the opening 212 serves to remove the gas present in the line 92 to the combustion gas heat recovery zone 5,

the opening 151 serves to remove the oxygen-containing gas present in the line 9 to the atmosphere via the stack 40, the louvers 15 serving to regulate this flow.

If the gas turbine 3 is in operation and produces an oxygen-containing gas, the hatches 111 and 113 are installed so as to close the openings 11 and 112: this serves to supply the combustion chamber of the unit 7 and the combustion gas heat recovery zone 5 with exhaust gas from the turbine 3. Using the louvers 4 and 16, it is possible to send as required more or less exhaust gas from the turbine 3 either to the line 91 and the combustion chamber of the unit 7, or to the line 92 and the combustion gas heat recovery zone 5. Furthermore, the louver 16 is servocontrolled by the sensor 100 for measuring the oxygen pressure and/or concentration of the syngas production unit by feedback loop: its opening can be adjusted as a function of this control in order to regulate the flow of exhaust gas 2 from the turbine 3 flowing in the line 91.

If the gas turbine 3 is not in operation, the hatches 111 and 113 are installed so as to open the openings 11 and 112 and thereby supply the combustion chamber 7 and the combustion gas heat recovery zone 5 with atmospheric air (secondary oxygen-containing gas). In this case, the burners 20 and 120 serve to preheat the atmospheric air. If the gas turbine 3 is inoperative and does not produce oxygen-containing gas, the louvers 4 and 16 are closed, the louvers 15 are adjusted in order to remove the gas from the turbine to the atmosphere via the stack 40. Simultaneously, the hatches 111 and 113 are installed so as to open the openings 11 and 112 and thereby supply the combustion chamber 7 and the combustion gas heat recovery zone 5 with atmospheric air (secondary oxygen-containing gas).

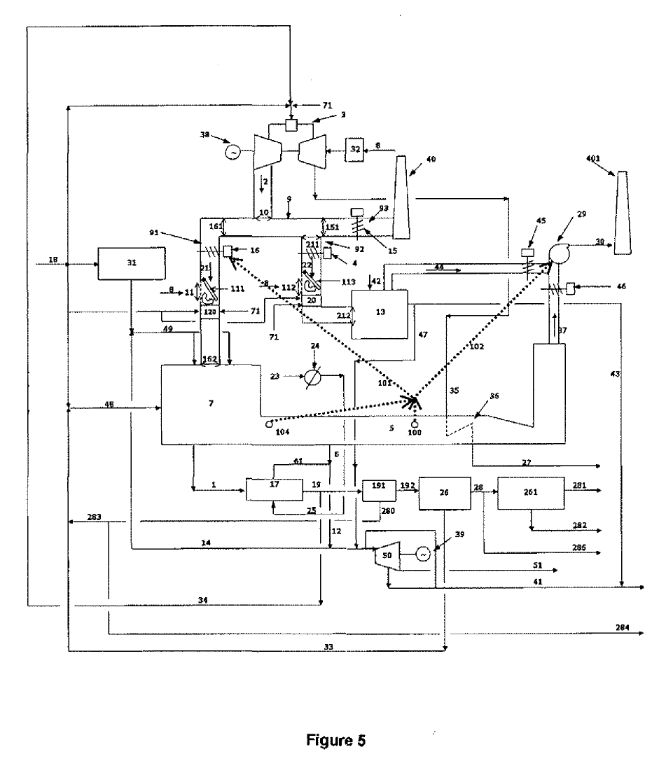

FIG. 5 shows a schematic view corresponding to the process in FIG. 2 showing details of the device for distributing exhaust gas 2 from the turbine 3 and secondary oxygen-containing gas into the combustion chamber of the syngas production device 7. This flowchart differs from the one in FIG. 4 in that it comprises a steam production unit 13 supplied with fuels 42 and with oxidizer by part 22 of the exhaust gas 2 issuing from the gas turbine 3. In this arrangement, the line 92 serves to supply oxygen-containing gas to this steam production unit 13 rather than to procure oxygen-containing gas from the combustion gas heat recovery zone 5.

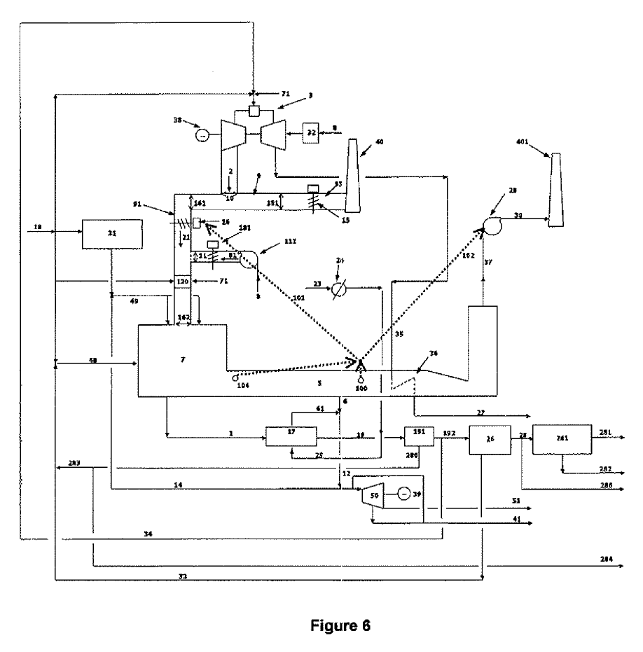

FIG. 6 shows a schematic view corresponding to the process in FIG. 3, showing details of the device for distributing exhaust gas 2 from the turbine 3 and secondary oxygen-containing gas into the combustion chamber of the syngas production device 7. This flowchart differs from the one in FIGS. 4 and 5 in that it does not comprise a line 92 for removing the oxygen-containing gas to the combustion gas heat recovery zone 5 or to the steam production unit 13.

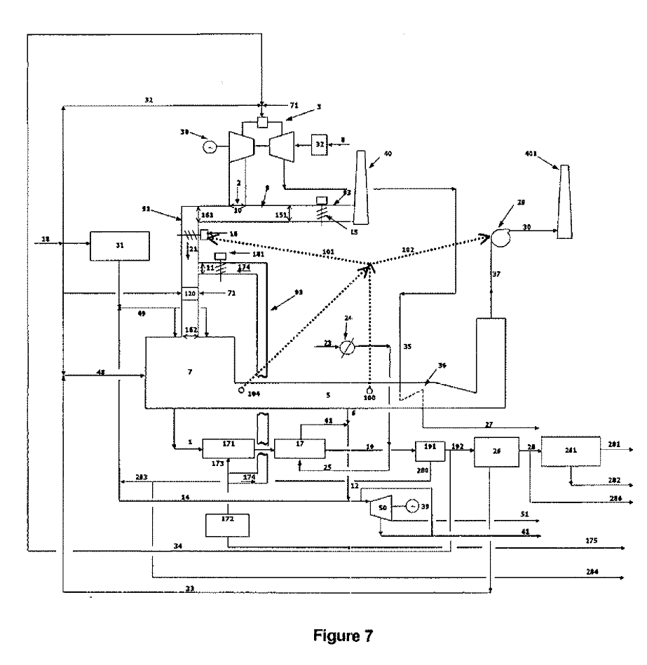

FIG. 7 is an alternative of the embodiment in FIG. 6 in which the opening 11, which serves to introduce secondary oxygen-containing gas into the line 91, is connected to a line 94 enabling the introduction of pure oxygen 174 issuing from an ASU 172 into the line 91. The ASU 172 also supplies pure oxygen 173 to a secondary reformer 171 and oxygen 175 for export.

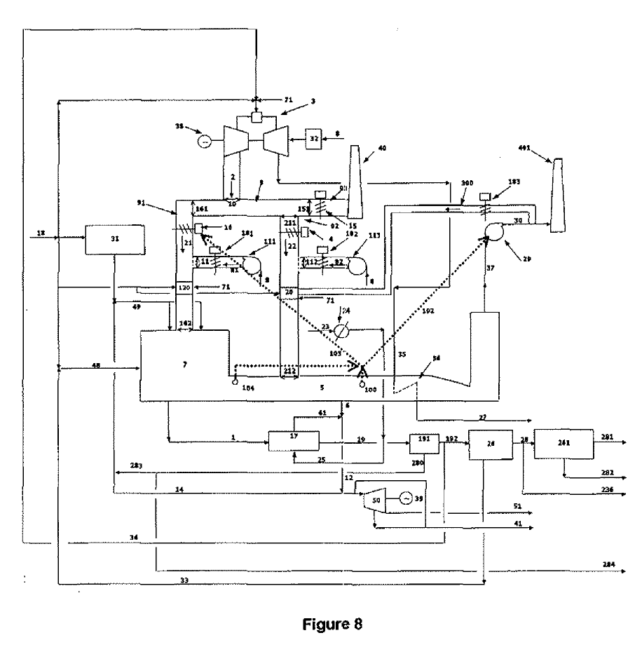

FIG. 8 shows an alternative of the embodiment in FIG. 4, in which part of the combustion products 30 from the syngas production unit is sent to the burner 20 of the line 90 via a line 300. Louvers 183 serve to adjust the flow of these combustion products 300. The recirculation of the combustion products serves to lower the flame temperature and to limit the production of nitrogen oxides NOₓ. The combustion product recirculation rate may vary between 15 and 20%. A reduction of about 40 to 55% of NOₓ emissions has been observed.

By the implementation of the invention, it has been found that the temporary or continuous use of the oxygen-containing gas from the gas turbine in the syngas production device allows the use of a single heat recovery section in said syngas production device, as shown in FIGS. 1, 3, 4, 6, 7 and 8, whereas it is normally necessary to use two. In certain cases, the quantity of fuel used by the syngas production device is reduced in comparison with the case in which the syngas production unit and the cogeneration unit are independent. It has also been observed that the quantity of steam produced can be increased during the use of the device of the invention comprising three lines by carrying out the post-combustion in the burners present in the third line. The invention in fact serves to regulate the flow rate, temperature and pressure for producing steam for export via the steam turbine.

Furthermore, the fuel and the hydrocarbon raw material and fuel used for the coproduction of electricity, steam and syngas are converted with 80% to 90% efficiency; this conversion rate cannot be reached by an independent power generation unit. The hot oxygen-containing gas issuing from the gas turbine helps to reduce the consumption of fuel required by the combustion chamber of the syngas production unit. The combustion gases are therefore more available for producing additional steam which can pass through a steam turbine to generate more electricity. This invention also serves to produce preheated air which can be used for regenerating catalysts in certain industrial processes. In short, a sharp increase in thermal and electrical efficiency is achieved by an increase in the production of steam and electricity, accompanied by a drop in consumption of gas as fuel.

According to the invention, the fact that the oxygen-containing gas issuing from the gas turbine is hot serves to decrease the fuel consumption in the combustion chamber of the syngas production device. The combustion gas heat recovery zone can also replace a steam production unit of a cogeneration unit. Once the heat of the oxygen-containing gas and the combustion gas is recovered, the cooled exhaust gas is tapped off by a blower and removed via a stack. The steam obtained in the steam recovery unit of the syngas production device 17, the combustion gas heat recovery zone 5 and the steam production unit 13, can be introduced either into a backpressure steam turbine which produces steam and electricity, or into a steam condensing turbine producing hot water and electricity.

Furthermore, the generator of the gas turbine produces electricity which can be used by the auxiliary facilities, for example fans, compressors and pumps, which are found in the integrated plant.

In the arrangement shown in FIG. 7 and providing, in case of shutdown of the turbine, for the use of oxygen issuing from an ASU instead of atmospheric air, the following advantages are obtained: improved efficiency of the heat recovery unit (due to the absence of nitrogen), lower NOₓ emissions, decrease in the quantity of gas used as fuel.

The invention provides flexibility to the industrial site and a wider product range for the production of syngas, CO, hydrogen, oxogas (mixture of H₂ and CO in a precise ratio), steam, hot air and electricity.

The syngas production device can be equipped with exhaust gas treatment systems such as a “Selective Catalytic Removal of NOₓ” (SCR) unit to control the NOₓ content issuing from the combustion gas, or a device for cleaning exhaust gas to remove the carbon dioxide, particulates and sulfur oxides.

1-9. (canceled)

10. A method for supplying oxidizer to the combustion device of a unit for producing syngas from the exhaust gas produced by a gas turbine, wherein the exhaust gas flow introduced into the combustion device is controlled according to the value of the oxygen concentration and/or of the pressure in the furnace of the syngas production unit.

11. The method of claim 10, wherein the flow of exhaust gas from the gas turbine introduced into the combustion device is controlled by at least one control means placed on the device for distributing the exhaust gas to the combustion device.

12. The method of claim 10, wherein the flow of exhaust gas from the gas turbine introduced into the combustion device is controlled by at least one extractor fan withdrawing the combustion products at the outlet of the syngas production unit.

13. The method of claim 10, wherein the flow of exhaust gas from the gas turbine introduced into the combustion device is controlled so that the oxygen concentration downstream of the combustion chamber of the syngas production unit is between 2 and 3% by volume.

14. The method of claim 10, wherein the flow of exhaust gas from the gas turbine introduced into the combustion device is controlled so that the pressure downstream of the combustion chamber of the syngas production unit is between −5 mm and −15 mm H₂O.

15. A device for supplying oxidizer to the combustion device of a unit for producing syngas from the exhaust gas produced by a gas turbine for implementing the method of claim 10, wherein it consists of at least two lines, the first line comprising;
a) an opening cooperating with the gas turbine and enabling the introduction of the exhaust gas from the gas turbine into said first line;
b) an opening cooperating with the second line and enabling the removal of the gas present in the first line to the second line; and
c) an opening enabling the removal of the gas present in said line to the atmosphere;
the second line comprising:
d) an opening cooperating with the first line and enabling the introduction of the exhaust gas from the gas turbine into said second line;
e) an opening enabling the introduction of a secondary oxygen-containing gas into said second line;
f) means for controlling the opening enabling the introduction of the secondary oxygen-containing gas into the second line, enabling either the opening, or the closure of the opening;
g) an opening enabling the removal of the oxygen-containing gas present in the second line to the combustion device of a syngas production unit; and
h) means for regulating the flow of exhaust gas from the gas turbine.

16. The device of claim 15, wherein the means for regulating the flow of exhaust gas from the gas turbine into the second line is servocontrolled by an oxygen pressure and/or concentration sensor located downstream of the combustion chamber of the syngas production unit.

17. The device of claim 15, enabling the distribution of the exhaust gas from the gas turbine into a combustion gas heat recovery zone and/or to a unit for producing steam, wherein it comprises three lines and in that:
a) the first line comprises an opening cooperating with the third line and enabling the removal of the gas present in the first line to the third line; and
b) the third line comprises:
1) an opening cooperating with the first line and enabling the introduction of the exhaust gas from the gas turbine into said third line,
2) an opening enabling the introduction of the secondary oxygen-containing gas into said second line;
3) means for controlling the opening enabling the introduction of the secondary oxygen-containing gas into the third line enabling either the opening, or the closure of the opening; and
4) an opening enabling the removal of the oxygen-containing gas present in the third line to the combustion gas heat recovery zone and/or to the unit for producing steam.

18. The device of claim 17, wherein the first line comprises means for dividing the exhaust gas from the gas turbine between the second line and the third line.
